(19) United States
(12) Patent Application Publication
(10) Pub. No.: US 2019/0308211 A1
(43) Pub. Date: Oct. 10, 2019

(54) COATING DEVICE AND ASSOCIATED OPERATING METHOD

(71) Applicant: Dürr Systems AG, Bietigheim-Bissingen (DE)

(72) Inventors: Hans-Georg Fritz, Ostfildern (DE); Benjamin Wöhr, Eibensbach (DE); Marcus Kleiner, Besigheim (DE); Moritz Bubek, Ludwigsburg (DE); Timo Beyl, Besigheim (DE); Frank Herre, Oberriexingen (DE); Steffen Sotzny, Oberstenfeld (DE)

(21) Appl. No.: 16/468,692

(22) PCT Filed: Dec. 1, 2017
(86) PCT No.: PCT/EP2017/081099

§ 371 Date: Jun. 12, 2019

(30) Foreign Application Priority Data
Dec. 14, 2016 (DE) 10 2016 014 951.5

(51) Int. Cl. B05B 12/08; B05B 12/14; B05B 15/40; B05B 15/58

(52) U.S. Cl. CPC B05B 12/082; B05B 12/085; B05B 15/58; B05B 15/40; B05B 12/149

(57) ABSTRACT

The disclosure relates to a coating installation for coating components with a coating agent, in particular for painting motor vehicle body components, with a nozzle applicator, in particular a print head, with at least one nozzle for delivering a coating agent jet of the coating agent onto the component to be coated. The disclosure provides a device for preventing and/or detecting clogging of the nozzle.

### CROSS-REFERENCE TO RELATED APPLICATIONS

This application is a national stage of, and claims priority to, Patent Cooperation Treaty Application No. PCT/EP2017/081099, filed on Dec. 1, 2017, which application claims priority to German Application No. DE 10 2016 014 951.5, filed on Dec. 14, 2016, which applications are hereby incorporated herein by reference in their entireties.

### BACKGROUND

The disclosure concerns a coating installation for coating components with a coating agent, in particular for painting vehicle body components. Furthermore, the disclosure concerns an associated operating method for such a coating installation.

For the serial painting of car body components, rotary atomizers are usually used as application devices, which have the disadvantage of a limited application efficiency, i.e. only a part of the applied paint is deposited on the components to be coated, while the rest of the applied paint has to be disposed of as so-called overspray.

A newer development line, on the other hand, provides for so-called print heads as application equipment, as known for example from DE 10 2013 002 412 A1, U.S. Pat. No. 9,108,424 B2 and DE 10 2010 019 612 A1. In contrast to the known rotary atomizers, such print heads do not emit a spray mist of the paint to be applied, but a paint jet that is spatially narrowly confined and almost completely deposited on the component to be painted, so that almost no overspray occurs.

However, such printheads usually have nozzles with a very small nozzle diameter of less than 500 μm or even less than 100 μm. However, such small nozzles can easily clog or even completely clog during operation. For example, individual paint particles can initially deposit in the nozzle, which initially only adversely affect the otherwise laminar flow of coating agent, for example by causing turbulence. Further deposition of paint particles can lead to complete clogging of the nozzle.

With regard to the general technical background of the disclosure, reference should also be made to DE-AS 1 284 250, DE 10 2004 021 223 A1, GB 2 507 069 A, DE 103 31 206 A1, WO 2016/145000 A1, EP 0 297 309 A2, DE 689 24 202 T2, DE 103 07 719 A1 and DE 30 45 401 A1. However, some of these publications do not concern nozzle applicators, but spray applicators which emit a spray jet. In some cases, however, the coating installation known from these publications also suffers from the problems described above.

### BRIEF DESCRIPTION OF THE DRAWINGS

FIG. 1 a schematic representation of a coating installation according to disclosure with a nozzle applicator and a filter to prevent clogging of the nozzles of the nozzle applicator,

FIG. 2 a variation of FIG. 1 with two optional filters,

FIG. 3 a modification of FIG. 3 with a color changer and numerous filters in the feed lines of the color changer,

FIG. 4A a schematic representation of a coating installation according to the disclosure having a camera-based means for detecting clogging of the nozzles of the nozzle applicator,

FIG. 4B a variation of FIG. 4A,

FIG. 5 a modification of FIG. 4A or 4B with several light barriers for measuring the coating agent jets,

FIG. 6 a modification of FIG. 5 with a capacitive sensor that measures all coating agent jets together,

FIG. 7 a variation of FIG. 6 with a capacitive sensor that measures the flow of coating agent in a channel carrying coating agent.

### DETAILED DESCRIPTION

The disclosure is based on the task of finding a solution to the problem of complete or partial clogging of the nozzles in a nozzle applicator (e.g. print head).

The coating installation according to the disclosure is used for coating components with a coating agent, in particular for painting vehicle body components.

The components to be coated do not necessarily have to be motor vehicle body components. Rather, the coating installation according to the disclosure can also be used for coating other types of components.

It should also be mentioned that the coating agent is preferably a paint, such as a base coat, a clear coat, a water-based paint or a solvent-based paint. Within the scope of the disclosure, however, the coating installation may also be designed for the application of other coating agents, such as adhesives, insulating materials, sealants, primers, etc.

The coating installation according to the disclosure initially has a nozzle applicator in accordance with the state of the art, such as a print head as mentioned at the beginning and described in DE 10 2013 002 412 A1, U.S. Pat. No. 9,108,424 B2 and DE 10 2010 019 612 A1, so that a detailed description of the structure and function of such print heads can be dispensed with.

The coating installation features an additional device to prevent and/or detect nozzle clogging. One aspect of the disclosure is therefore to prevent clogging of the nozzle. Another aspect, on the other hand, is based on the fact that clogging of the nozzle with a resulting deterioration of the coating quality is detected so that countermeasures can be taken if necessary.

In the disclosure, clogging of the nozzle can be prevented, for example, by a filter arranged upstream of the nozzle which filters the coating agent so that, for example, solid coating agent particles are filtered out as these could lead to clogging of the nozzle.

It should be noted that the filter preferably has a certain filter mesh size, which is preferably adapted to the nozzle size of the nozzle opening of the nozzle. For example, the ratio of the filter mesh size to the nozzle size can be in the range of 0.01-5, whereby any intermediate intervals are possible. Preferred values for the ratio of the filter mesh size to the nozzle size are for example 0.075, 0.1, 0.15, 0.66, 1.0 and 2.0.

In an example of the disclosure, this filter can be rinsed with a flushing agent in order to be able to rinse out filtered coating agent residues from the filter again. For this purpose, the filter is flushed with a flushing agent. The flushing agent can be passed through the filter either against the normal flow direction or in the normal flow direction. In addition, it is also possible for the flushing agent to be passed through the filter alternately against the normal flow direction and in the normal flow direction during a rinsing process in order to achieve the best possible rinsing effect. The coating installation therefore preferably has a flushing agent connection to supply the flushing agent. In addition, the coating installation preferably has a recirculation connection in order to recirculate a mixture of coating agent residues and flushing agent. The coating installation may also have a flushing valve arrangement connected to the flushing agent connection and the return connection on the one hand and to two corresponding filter connections on the other hand. The flushing valve arrangement preferably enables a bidirectional flushing of the filter with the flushing agent, i.e. either against the normal flow direction or in the normal flow direction.

The disclosure also makes it possible for the filter to be a double filter with two individual filters arranged parallel to each other. The coating agent can then be directed either into one single filter or into the other single filter by means of a selection valve arrangement. In addition, the selection valve arrangement directs the flushing agent either into one individual filter or into the other individual filter. This allows the coating agent to flow through one filter while the other filter is flushed. Such an operation can also be referred to as A/B operation, as it is known in the field of painting technology for so-called A/B valves. In this way, the necessary rinsing processes do not lead to an interruption of the normal coating operation, as the other individual filter is still available for filtering the coating agent during the rinsing of one individual filter.

It should also be mentioned that the coating installation according to the disclosure may have a metering pump which conveys the coating agent to the nozzle applicator. The filter can be arranged either between the metering pump and the nozzle applicator or upstream of the metering pump.

In addition, the coating installation according to the disclosure in an example includes a colour changer which selects a desired coating agent from several coating agent supply lines and forwards it to the nozzle applicator. Here it is possible that a filter is arranged in each of the individual coating agent supply lines upstream of the colour changer in order to filter the supplied coating agent. The individual filters at the inputs of the colour changer can then be individually adapted to the respective coating agent.

It should also be mentioned that the filter may have internal contours that are free of undercuts. In addition, the internal surfaces of the filter in the flowed through areas preferably have a very low roughness number Rz<10, Rz<8, Rz<7, Rz<6.3, Rz<5 or even Rz<4.

It has already been briefly mentioned above that a second aspect of the disclosure is not aimed at preventing the clogging of the nozzle, but at detecting the clogging of a nozzle. This aspect of the disclosure therefore prefers a sensor arrangement in order to be able to distinguish a fault-free jet delivery from a faulty jet delivery.

In an example of the disclosure, the sensor arrangement has an image sensor, such as a camera. The image sensor captures an image of at least one coating agent jet or several coating agent jets emitted by the nozzle applicator. Here, the viewing axis of the image sensor (e.g. camera) is preferably orthogonal to the coating agent jets and parallel to the plane of the coating agent jets, i.e. the image sensor observes the coating agent jets from the front. It is also possible, however, that the viewing axis is aligned transversely to the plane of the coating agent jets, i.e. the image sensor looks at the coating agent jets from the side. In a special version, both views can be acquired one after the other or by means of two sensors. In addition, the sensor arrangement in this example may have an image evaluation unit that evaluates the image of the coating agent jets captured by the image sensor and detects errors therein, such as a missing coating agent jet due to the clogging of a nozzle.

The image acquisition can be improved by an illumination device, which is arranged in the line of sight of the image sensor on the opposite side of the coating agent jets.

The image evaluation unit can preferably detect and distinguish the following errors:
an oblique coating agent jet which exits obliquely to the nozzle axis due to partial clogging of a nozzle,
an unstable coating agent jet that prematurely disintegrates into coating agent droplets,
a coating agent jet with an insufficient amount of coating agent,
a disturbed coating agent jet, and/or a missing coating agent jet due to complete clogging of the nozzle.

In another example of the disclosure, the sensor arrangement has a capacitive sensor which measures several coating agent jets together.

Alternatively, however, it is also possible for the capacitive sensor to measure only one single coating agent jet capacitively, whereby a capacitive sensor is then preferably provided for each nozzle.

In another example of the disclosure, the sensor arrangement has a light barrier, whereby the coating agent jet from the nozzle passes through the light barrier and is measured by the light barrier. Each nozzle is preferably assigned a light barrier, which is passed by the respective coating agent jet.

In another example of the disclosure, the coating agent flows through a coating agent channel and is measured in the coating agent channel by a capacitive sensor or by a resistive sensor (resistance sensor) in order to infer errors (e.g. insufficient flow rate).

In general it should be mentioned that the print head preferably emits a narrowly limited jet of coating agent in contrast to a spray mist, as is the case with conventional atomizers (e.g. rotary atomizers).

The print head, for example, can emit a droplet jet as opposed to a continuous jet of coating agent in the longitudinal direction of the jet.

Alternatively, it is also possible for the print head to emit a coating agent jet being continuous in the longitudinal direction of the jet, as opposed to a droplet jet.

Preferably, the print head has a very high application efficiency of at least 80%, 90%, 95% or even 99%, so that essentially the entire applied coating is completely deposited on the component, without the formation of annoying overspray.

In addition, it should be noted that the print head preferably has a high areal coating performance which is preferably so large that the print head is suitable for painting automotive body parts. The areal coating performance of the nozzle applicator is therefore preferably greater than 0.5 m²/min, 1 m²/min or even 3 m²/min.

The nozzle applicator is preferably moved by means of a manipulator, which is preferably a multi-axis painting robot with serial robot kinematics and at least six movable robot axes.

The control of the coating agent delivery in the nozzle applicator is preferably carried out by control valves with a controllable actuator, such as a magnetic actuator or a piezo actuator.

It should also be mentioned that the disclosure does not only claim protection for the nozzle applicator described above with the device for preventing or detecting the clogging of a nozzle. Rather, the disclosure also claims protection for a complete painting facility, for example for painting car body components.

In addition, the disclosure also includes a corresponding operating method, whereby the procedural steps of the operating method already result from the above description and therefore do not have to be described separately.

In a modification of the operating method according to the disclosure, the nozzle applicator with opened nozzles is moved over a test surface (e.g. fleece, glass plate), whereby the nozzle applicator applies coating agent jets to the test surface and thereby produces a spray pattern on the test surface. The spray pattern can then be used to determine whether the nozzles are partially or completely clogged. The operating method according to the disclosure therefore provides in this variant that the spray pattern is evaluated on the test surface, for example with a camera and an image evaluation unit.

After a deviation has been detected, the following actions, for example, can be triggered:

Error message,

Back-flushing of applicator or nozzle plate, back-flushing (i.e. from outside to inside),

Nozzle cleaning (from outside and from inside to outside),

Replacement of applicator (completely).

With regard to the frequency of the above-mentioned test, the following possibilities exist, for example:

Execution of the test before each car body,

Execution of the test at predetermined intervals,

Execution of the test in predetermined time intervals in which no application is performed,

Execution of the test after each colour change,

Execution of the test at the start of production,

Execution of the test at the beginning of each shift,

Execution of the test at the end of each shift,

Execution of the test at the end of production,

Execution of the test after each fault,

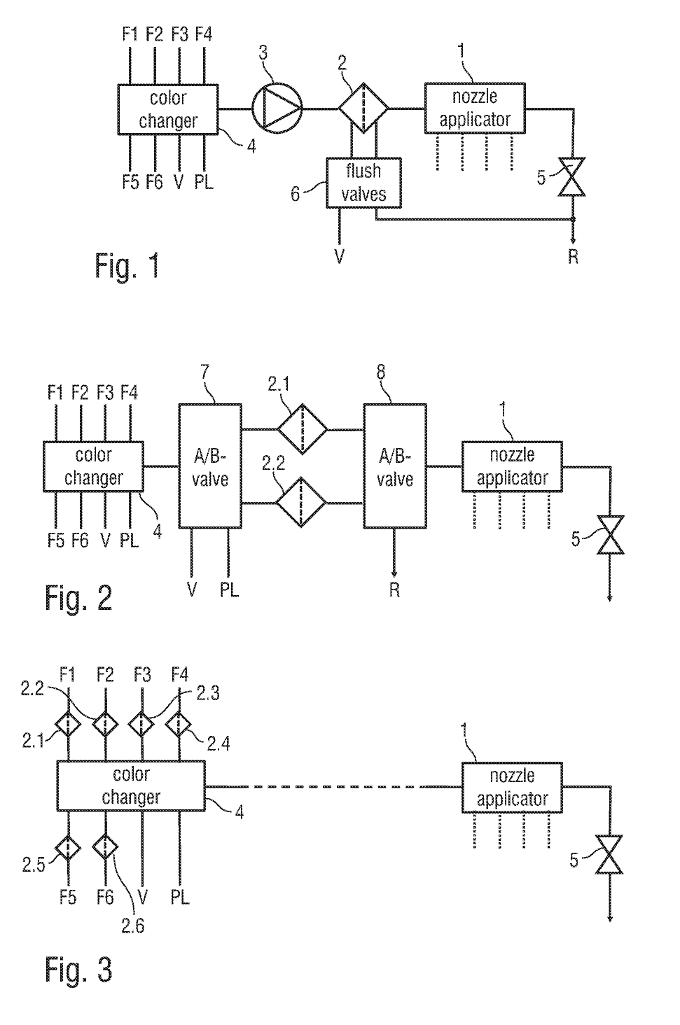

Referring to the Figures, FIG. 1 shows a simplified representation of a coating installation according to the disclosure with a nozzle applicator 1 as application device, whereby it can be, for example, a print head which emits spatially narrowly limited coating agent jets instead of a spray mist, as is the case with conventional atomizers (e.g. rotary atomizers).

The nozzle applicator 1 is supplied with the paint to be applied via a filter 2, a metering pump 3 and a color changer 4. For this purpose, the color changer 4 is connected on the input side to several coating agent supply lines F1-F6, via which different colored paints can be supplied.

In addition, the colour changer 4 is connected on the input side to a pulse air line PL and to a thinner line V, via which pulse air or flushing agent (thinner) can be supplied for flushing the nozzle applicator 1, the filter 2 and the metering pump 3.

In addition, the coating installation has a feedback valve 5 through which rinsed coating agent residues and flushing agent can be fed into a feedback R. The coating installation is equipped with a feedback valve 5 for the flushing of the coating agent and the flushing agent.

It should be mentioned here that the nozzle applicator 1 has numerous nozzles with a very small nozzle diameter, so that there is a risk of clogging of the nozzles of nozzle applicator 1. The filter 2 reduces this risk of clogging of the nozzles, as the filter 2 filters out coating components which can lead to clogging of the nozzles.

It should also be mentioned that the filter 2 can be flushed in order to flush out the filtered coating components from filter 2. For this purpose, the coating installation has a flushing valve arrangement 6, which is connected on the input side to the flushing agent supply line V and to the return line R. In addition, the flushing valve arrangement 6 is connected to an upstream and a downstream flushing connection of the filter 2. The flushing valve arrangement 6 can therefore optionally direct flushing agent through the filter 2 in the normal flow direction or against the normal flow direction in order to flush out coating agent residues from the filter 2.

FIG. 2 shows a modification of FIG. 1 so that the above description is referred to in order to avoid repetition, using the same reference signs for corresponding details.

A feature of this example is that two single filters 2.1, 2.2 are provided which are connected in parallel. Upstream and downstream behind the two individual filters 2.1, 2.2 is a selection valve arrangement 7 and 8, respectively, which is connected to the two individual filters 2.1, 2.2.

The upstream selection valve arrangement 7 can supply coating agent and flushing agent either to the single filter 2.1 or to the single filter 2.2.

The downstream selection valve arrangement 8, on the other hand, can take up coating agent from one single filter 2.1 or 2.2 and supply it to nozzle applicator 1 and take up flushing agent and coating agent residues from the other single filter 2.2 or 2.1 and direct them to the recirculation R. The individual filters 2.1 and 2.2 can be connected to the individual filter 2.1 or 2.2.

In this way a so-called A/B operation is possible in which coating agents always flow through one of the two individual filters 2.1 or 2.2, while the other individual filter 2.2 or 2.1 is flushed with flushing agent.

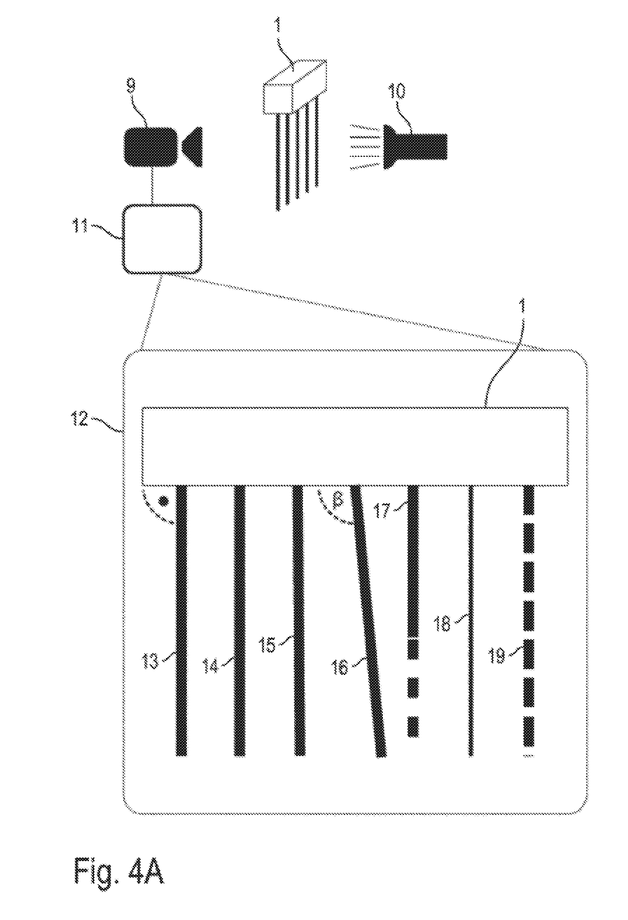

FIG. 3 shows a further modification, so that to avoid repetitions, reference is made to the above description, using the same reference signs for the relevant details.

A feature of this example is that a filter 2.1-2.6 is arranged in each of the coating agent supply lines F1-F6. This offers the possibility that the filter characteristics and filter properties of the individual filters 2.1-2.4 can be individually adapted to the properties of the respective coating agent.

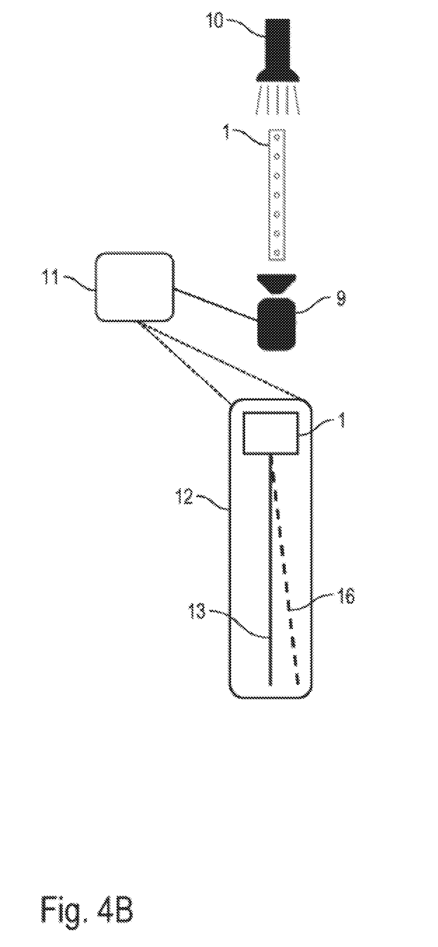

The following is a description of the example according to FIG. 4A, which is based on a second aspect of the disclosure in which the clogging of the nozzles of nozzle applicator 1 is detected so that countermeasures can then be taken if necessary.

For this purpose, the coating installation initially has a camera 9 which is arranged laterally next to the nozzle applicator 1 and is aligned with its viewing axis substantially at right angles to the plane of the coating agent jets. The camera 9 thus looks at the coating agent jets of nozzle applicator 1 from the side.

To improve image acquisition, an illumination device 10 is arranged on the opposite side of the coating agent jets.

The camera 9 is connected on the output side to an image evaluation unit 11, which evaluates the image of the coating agent jets captured by the camera 9 in order to detect errors.

For example, the lower part of the drawing shows an exemplary simplified representation of a captured image 12 with several coating agent jets 13-19.

The coating agent jets 13-15 are error-free.

The coating agent jet 16, on the other hand, emerges obliquely from nozzle applicator 1, which can be caused by partial clogging of the nozzle in question.

The coating agent jet 17, on the other hand, is unstable.

The coating agent jet 18, on the other hand, contains too little coating agent, which can be caused by partial clogging of the coating agent supply.

Finally, the coating agent jet 19 is disturbed.

The image evaluation unit 11 enables the detection and differentiation of the different types of faultless or faulty coating agent jets 13-19.

FIG. 4B shows a modification of FIG. 4A, so that to avoid repetitions, reference is made to the above description, using the same reference signs for corresponding details.

A feature of this example is that the line of sight of the camera 9 is perpendicular to the individual coating agent jets, but parallel to the plane of the coating agent jets.

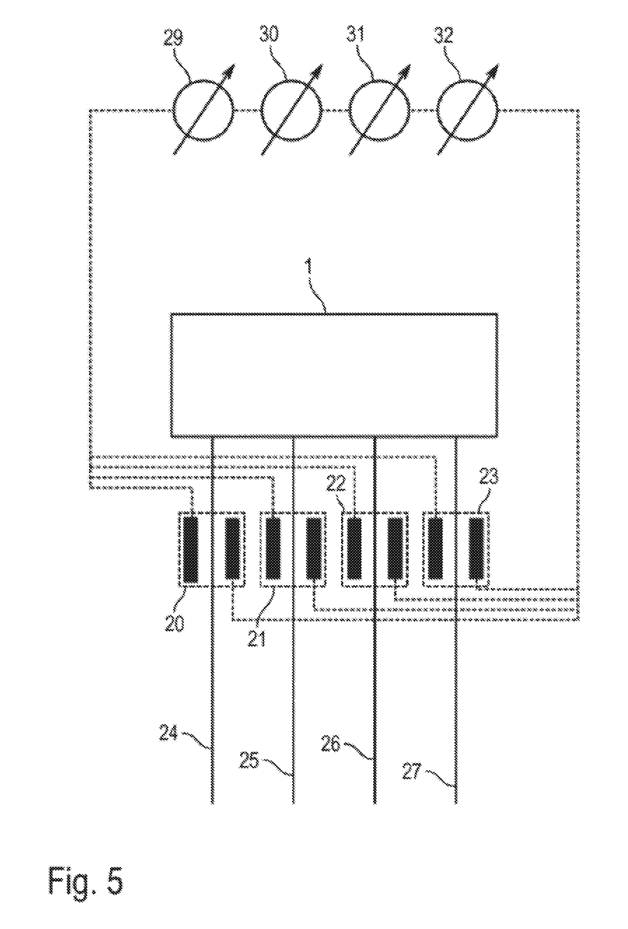

FIG. 5 shows a variation of the example in FIG. 4A and FIG. 4B, respectively, so that to avoid repetition, reference is made to the above description, using the same reference signs for appropriate details.

A feature of this example is that instead of the camera-based image acquisition system, several light barriers 20-23 are provided, each of which measures a coating agent jet 24-27 and is connected to an evaluation unit 28-31 to detect a missing coating agent jet.

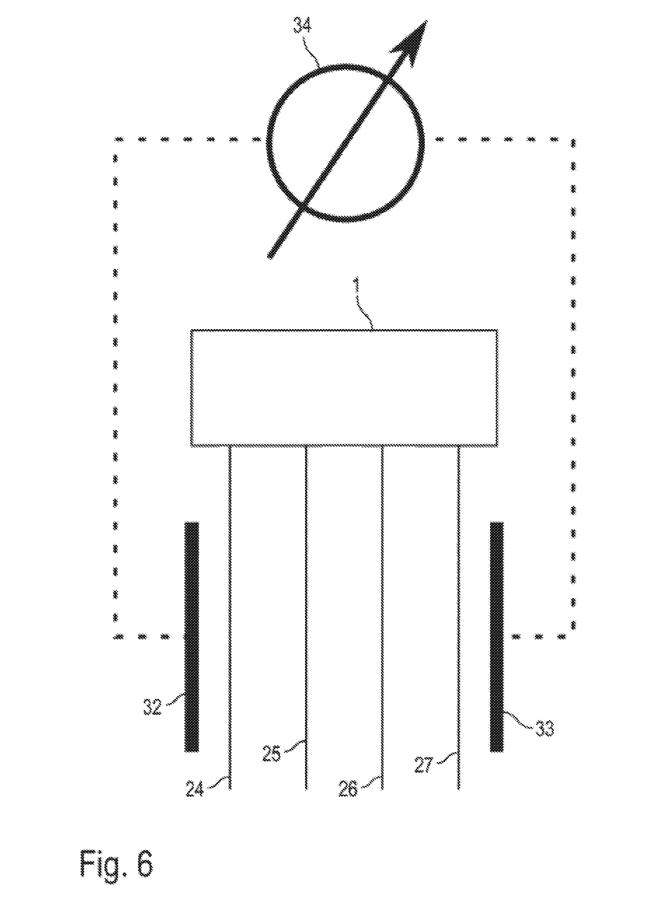

FIG. 6 shows a further variation so that, to avoid repetition, reference is made again to the above description, using the same reference signs for the relevant details.

A feature of this example is that instead of the light barriers 20-23 a capacitive sensor with two capacitor plates 32, 33 is used to measure the coating agent jets 24-27. The coating agent jets 24-27 thus run between the two capacitor plates 32, 33, so that the capacitive sensor measures all coating agent jets 24-27 together.

On the output side, the capacitive sensor 32, 33 is connected to an evaluation unit 34, which can detect faults.

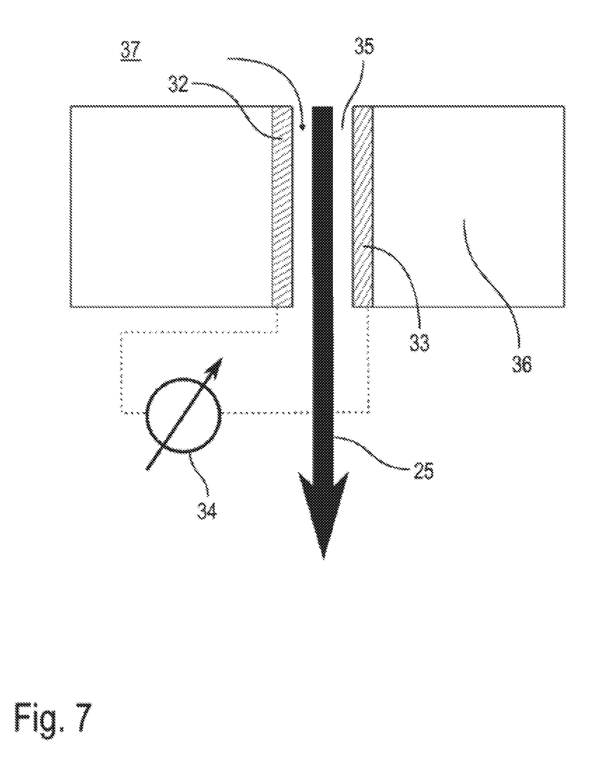

The example shown in FIG. 7 partially corresponds to the example shown in FIG. 6, so that reference is made to the above description to avoid repetitions, whereby the same reference signs are used for corresponding details.

A feature of this example is that the two capacitor plates 32, 33 of the capacitive sensor are arranged on the walls of a nozzle channel 35 which runs through a nozzle plate 36. The capacitive sensor with the two capacitor plates 32, 33 thus measures the coating agent flow through the nozzle channel 35 and can thus detect faults. The coating agent is fed through a paint feed 37 in the print head.

The disclosure is not limited to the preferred examples described above. Rather, the disclosure comprises a large number of variants and modifications which also make use of the inventive idea and therefore fall within the scope of protection. In particular, the disclosure also claims protection for the subject-matter and the features of the dependent claims independently of the claims referred to in each case. The disclosure thus comprises a large number of aspects of the disclosure which enjoy protection independently of each other.

1.-17. (canceled)

18. Coating installation for coating components with a coating agent, with
a) a nozzle applicator having at least one nozzle for dispensing a coating agent jet of the coating agent onto the component to be coated,
b) means for preventing nozzle clogging.

19. Coating installation according to claim 18, wherein the means for preventing comprising a filter upstream of the nozzle for filtering the coating agent.

20. Coating installation according to claim 19, wherein
a) the nozzle has a nozzle orifice with a predetermined nozzle size, and
b) the filter has a specific filter mesh width, and
c) the ratio of the filter mesh width to the nozzle size is greater than 0.01, and
d) the ratio of the filter mesh size to the nozzle size is less than 5.

21. Coating installation according to claim 19, wherein
a) the coating agent flows through the filter in a normal flow direction during coating operation,
b) the coating installation is adapted so that the filter can be flushed in the normal flow direction with a flushing agent, so that the flushing agent flows through the filter in the normal flow direction.

22. Coating installation according to claim 19, wherein
a) the coating agent flows through the filter in a normal flow direction during coating operation,
b) the coating installation is adapted so that the filter can be flushed with a flushing agent against the normal flow direction, so that the flushing agent flows through the filter against the normal flow direction.

23. Coating installation according to claim 21, wherein
a) the coating installation comprises a flushing agent port for supplying said flushing agent, and
b) the coating installation has a return port for returning a mixture of coating agent and flushing agent to a return, and
c) the coating installation comprises a flushing valve arrangement for selectively passing the flushing agent through the filter in the normal flow direction or against the normal flow direction.

24. Coating installation in accordance with claim 19, wherein
a) the filter is a double filter having two individual filters which are arranged parallel to one another,
b) the coating agent is passed by a selection valve arrangement selectively into one individual filter or into the other individual filter,
c) the flushing agent is passed by the selection valve arrangement selectively either into one individual filter or into the other individual filter, and
d) one individual filter is flowed through by the flushing agent, while the other individual filter is flowed through by the coating agent.

25. Coating installation according to claim 19, wherein the filter is arranged between a metering pump and the nozzle applicator.

26. Coating installation according to claim 25, wherein the filter is arranged upstream of the metering pump.

27. Coating installation in accordance with claim 19, wherein
a) the coating installation has a colour changer which selects a desired coating agent from a plurality of coating agent supply lines and forwards it to the nozzle applicator,
b) a respective filter is arranged in the coating agent feed lines upstream of the colour changer.

28. Coating installation according to claim 27, wherein the filters at the input of the colour changer are different and adapted to the respective coating agent.

29. Coating installation in accordance with claim 19, wherein the filter has internal contours which are free of undercuts.

30. Coating installation according to claim 19, wherein the filter has internal surfaces with a roughness number Rz<10.

31. Coating installation according to claim 18, further comprising a sensor arrangement for distinguishing a faultless jet delivery from a faulty jet delivery through the nozzle applicator.

32. Coating installation according to claim 18, wherein the nozzle has a nozzle diameter of less than 1 mm.

33. Coating installation for coating components with a coating agent, with
a) a nozzle applicator having at least one nozzle for dispensing a coating agent jet of the coating agent onto the component to be coated,
b) means for detecting nozzle clogging.

34. Coating installation according to claim 33, wherein the means for detecting is a sensor arrangement for distinguishing a faultless jet delivery from a faulty jet delivery through the nozzle applicator.

35. Coating installation according to claim 34, wherein
the sensor arrangement has an image sensor, which detects an image of the coating agent jets.

36. Coating installation according to claim 35, wherein the visual axis of the image sensor is aligned transverse to the plane of the coating agent jets and transverse to the individual coating agent jets.

37. Coating installation according to claim 35, wherein the visual axis of the image sensor is aligned in the plane of the coating agent jets and transverse to the individual coating agent jets.

38. Coating installation according to claim 35, wherein the sensor arrangement has an image evaluation unit which evaluates the image detected by the image sensor and recognizes errors therein.

39. Coating installation according to claim 35, wherein a lighting device is provided which is arranged in the visual axis of the image sensor on the opposite side of the coating agent jets.

40. Coating installation according to claim 38, wherein the image evaluation unit detects at least one of the following error cases by the image evaluation:
a) an oblique coating agent jet which emerges obliquely to the nozzle axis,
b) an unstable coating agent jet which disintegrates into coating agent droplets,
c) a coating agent jet with an insufficient amount of coating agent,
d) a disturbed coating agent jet,
e) a missing coating agent jet due to clogging of the nozzle.

41. Coating installation according to claim 34, wherein the sensor arrangement comprises a capacitive sensor.

42. Coating installation according to claim 41, wherein the capacitive sensor jointly measures a plurality of coating agent jets.

43. Coating installation according to claim 41, wherein each nozzle is assigned in each case a capacitive sensor which capacitively measures the respective coating agent jet.

44. Coating installation in accordance with claim 34, wherein the sensor arrangement comprises a light barrier, the coating agent jet from the nozzle passing through the light barrier.

45. Coating installation according to claim 44, wherein each nozzle is assigned a respective light barrier which is passed by the respective coating agent jet.

46. Coating installation according to claim 34, wherein
a) the coating agent flows through a coating agent channel; and
b) a capacitive or resistive sensor measures the coating agent flow in the coating agent channel to infer from it error cases.
